(19) United States
(12) Patent Application Publication
(10) Pub. No.: US 2022/0300991 A1
(43) Pub. Date: Sep. 22, 2022

(54) SYSTEM AND METHOD FOR CUSTOMIZING A DIGITAL PLATFORM FOR A TARGET USER

(71) Applicant: FLIPKART INTERNET PRIVATE LIMITED, Bengaluru (IN)

(72) Inventors: Piyush Ranjan, Hajipur (IN); Ashish Gupta, Secunderabad (IN); Anmol Srivastava, Bengaluru (IN)

(73) Assignee: FLIPKART INTERNET PRIVATE LIMITED, Bengaluru (IN)

(21) Appl. No.: 17/696,693

(22) Filed: Mar. 16, 2022

(30) Foreign Application Priority Data
Mar. 18, 2021 (IN) 202141011618

(51) Int. Cl. G06Q 30/02

(52) U.S. Cl. CPC G06Q 30/0201; G06Q 30/0281; G06Q 30/0251

(57) ABSTRACT

A system and method for customizing a digital platform for a target user. The method encompasses receiving, at a transceiver unit [102], a target user selection number of at least one high value action (HVA) on the digital platform. The method thereafter comprises determining, by a processing unit [104], a quantile score for the target user based on a first set of users identified from a plurality of users on the digital platform. Further the method by the processing unit [104] determines an importance score for the HVA/s based at least on a successful placement of a first order by a second set of users identified from the plurality of users. The method thereafter encompasses determining, by the processing unit [104], a score for the HVA/s based on the quantile score and the importance score, to customize the digital platform.

### TECHNICAL FIELD

The field generally relates to digital platforms and more particularly to systems and methods for customizing a digital platform for a target user.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Over the past few years, digital platforms such as including but not limited to e-commerce platforms, social media platforms, mobile commerce platforms, websites and the like have been enhanced to a great extent. Also, with enhancements in digital technologies, more users are joining such digital platforms at a very rapid rate. Further, with the increase in new users on a digital platform, there arises a problem for new users to efficiently use the digital platform to perform one or more tasks digitally.

Further, to help users perform one or more operations on digital platforms, a number of solutions are developed time to time. For instance, various help sections, real time customer care support, tutorial videos and the like facilities are generally provided to the users. However, a user who is new on a digital platform may struggle while browsing the digital platform, and it may be difficult for him to access the provided facilities.

Furthermore, currently there is no framework to quantify a comfort/digital maturity of a user on a digital platform. Also, for instance a digital mature or comfortable user is someone who has transacted on a digital platform. Before completing the transaction, the user goes through various steps, such as, finding the right product, adding necessary information—login credentials, address, payment details, etc. A user who has made a transaction on a digital platform is familiar with various features of said digital platform and knows how to navigate through different pages. Thus, such user can be considered as mature or comfortable user on said digital platform. The currently known solutions fail to define comfort/digital maturity of a user on a digital platform.

Further, the currently known solutions also fail to provide a personalized experience to a user based on the comfort/digital maturity of the user on a digital platform. For example, a user new to internet/e-commerce may get overwhelmed while browsing on a regular internet/e-commerce platform because of information overload. The solutions known in the art fail to provide to the new user, a simpler version of such regular internet/e-commerce platform with less widgets/features, based on the comfort/digital maturity of the user.

Therefore, there is need in the art to provide a solution to determine a user's comfort/digital maturity on a digital platform to dynamically customize the digital platform according to the user's comfort/digital maturity to use such digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for customizing a digital platform for a target user. Another object of the present invention is to determine a digital maturity score of a user on a digital platform. Also, an object of the present invention is to quantify the comfort of a user on a digital platform to customize the digital platform. Another object of the present invention is to customize the digital platforms such as ecommerce platforms, mobile commerce platforms, social media platforms, and websites with call to action etc. based on a user's comfort to use such digital platforms. An object of the present invention is to provide an easy and simple user interface to the users who are not very digitally mature. Another object of the present invention is to determine digital maturity score of a user to provide the user a personalized experience based on comfort of the user on the digital platform. Another object of the present invention is to serve a simpler version of an application with less widgets/features for new users on such application. Also an object of the present invention is to make online shopping easy trustworthy and rewarding by providing a user specific customized e-commerce platform. Yet another object of the present invention is to customize a digital platform for a user based on his digital maturity score, wherein the customized digital platform includes at least one of one or more user specific options/features and a user specific user interface. Yet another object of the present invention is to identify users who struggle while browsing on a digital platform to make their experience progressive by making changes in user experience synchronous to their learning curve.

Furthermore, in order to achieve the aforementioned objectives, the present invention provides a method and system for customizing a digital platform for a target user.

A first aspect of the present invention relates to the method for customizing a digital platform for a target user. The method comprises receiving, at a transceiver unit, a target user selection number of at least one high value action (HVA) on the digital platform, wherein the digital platform includes one or more high value actions. The method thereafter comprises determining, by a processing unit, a quantile score for the target user based on a first set of users identified from a plurality of users on the digital platform, wherein the first set of users are identified based on the target user selection number of the at least one high value action (HVA) and a first user selection number of the at least one high value action (HVA). Further the method leads to determining, by the processing unit, an importance score for the at least one HVA based at least on a successful placement of a first order by a second set of users identified from the plurality of users, wherein the second set of users are identified based on an execution of the at least one HVA for successful placement of the first order. The method thereafter encompasses determining, by the processing unit, a score for the at least one HVA based on the quantile score and the importance score associated with said at least one HVA. The method further comprises customizing, by the processing unit, the digital platform for the target user based at least on the score of the at least one HVA.

Another aspect of the present invention relates to a system for customizing a digital platform for a target user. The system comprises a transceiver unit, configured to receive, a target user selection number of at least one high value action (HVA) on the digital platform, wherein the digital platform includes one or more high value actions. The system thereafter comprises a processing unit, configured to determine, a quantile score for the target user based on a first set of users identified from a plurality of users on the digital platform, wherein the first set of users are identified based on the target user selection number of the at least one high value action (HVA) and a first user selection number of the at least one high value action (HVA). The processing unit is further configured to determine, an importance score for the at least one HVA based at least on a successful placement of a first order by a second set of users identified from the plurality of users, wherein the second set of users are identified based on an execution of the at least one HVA for successful placement of the first order. Thereafter the processing unit is configured to determine, a score for the at least one HVA based on the quantile score and the importance score associated with said at least one HVA. Further the processing unit is configured to customize, the digital platform for the target user based at least on the score of the at least one HVA.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for customizing a digital platform for a target user, in accordance with exemplary embodiments of the present invention.

FIG. 2 illustrates an exemplary method flow diagram [200], depicting a method for customizing a digital platform for a target user, in accordance with exemplary embodiments of the present invention.

FIGS. 3A and 3B illustrate exemplary user interface diagrams, in accordance with exemplary embodiments of the present invention.

FIG. 4 illustrates an exemplary user interface diagram, in accordance with exemplary embodiments of the present invention.

FIG. 5 illustrates an exemplary user interface diagram, in accordance with exemplary embodiments of the present invention.

FIG. 6 illustrates an exemplary user interface diagram, in accordance with exemplary embodiments of the present invention.

The foregoing shall be more apparent from the following more detailed description of the disclosure.

### DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a display unit, a transceiver unit and any other such unit(s) which are obvious to the person skilled in the art and are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein the “Transceiver Unit” may include but not limited to a transmitter to transmit data to one or more destinations and a receiver to receive data from one or more sources. Further, the Transceiver Unit may include any other similar unit obvious to a person skilled in the art, to implement the features of the present invention. The transceiver unit may convert data or information to signals and vice versa for the purpose of transmitting and receiving respectively.

As disclosed in the background section the existing technologies have many limitations and in order to overcome at least some of the limitations of the prior known solutions, the present disclosure provides a solution for customizing a digital platform for a target user. More particularly, the present invention encompasses customizing the digital platform for the target user based at least on a target user's digital maturity score. The digital maturity score indicates a comfort or digital maturity of a user on a digital platform. Therefore, for new users on digital platforms, the digital maturity score is lower as compared to regular users on said digital platforms, as the new users are not very digital mature or comfortable on the digital platforms. Further, in accordance with the features of the present invention, the digital maturity score is determined based on a total score of one or more groups comprising one or more high value actions (HVAs) present on the digital platform, wherein each group indicates one or more steps/stages of a user during his/her user journey on the digital platform. Also, the one or more steps/stages are followed by the user by executing the one or more high value actions. Further the score of a group is determined based on a total score of the one or more HVAs present in said group. Therefore, the customization of the digital platform for the target user is based on a determination of a score for the one or more HVAs. Also, the high value actions (HVAs) are the actions performed by a user on a digital platform, for example for an e-commerce platform a high value action (HVA) may include but not limited to a sign up action, a product page view action, a sort action, a filter action, an add to wallet action, a social sharing action, an add to cart action, a PIN code check action, an add address action, a Login action, a return filed action, a repeat order action and the like. Further, a score for each HVA of the one or more HVAs is determined based on a product of a quantile score and an importance score associated with said each HVA. Furthermore, the quantile score indicates a percentile value associated with a number of times said each HVA is executed by one or more users and the importance score indicates a probability of execution of said each HVA at least once prior to a successful placement of a first order.

Further, once the target user's digital maturity score is identified, the present invention encompasses customizing the digital platform for the target user based on the digital maturity score of the target user. More particularly, the target user is categorized in a category based on the digital maturity score and thereafter at least one of one or more options and a particular user interface of the digital platform is provided as a customized digital platform, based on the category of the target user. Also, the present invention encompasses updating the category of the target user based on a change in the digital maturity score of the target user. Further, the present invention also encompasses customizing the digital platform for the target user based on the updated category. Therefore, the present invention provides a solution to customize a digital platform for a target user based on digital maturity of the target user.

Hereinafter, exemplary embodiments of the present disclosure will be described in detail with reference to the accompanying drawings so that those skilled in the art can easily carry out the present disclosure.

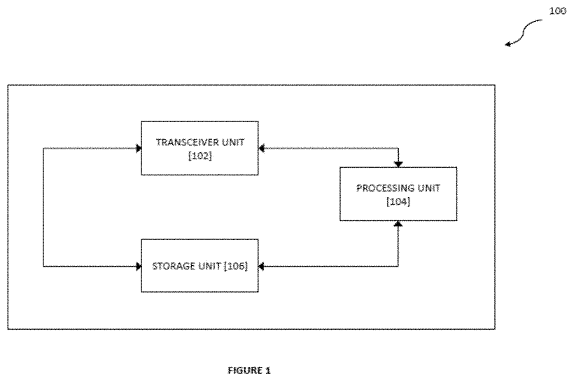

Referring to FIG. 1, an exemplary block diagram of a system [100] for customizing a digital platform for a target user, in accordance with exemplary embodiments of the present invention is shown. The digital platform can be accessed via an electronic/user device.

The system [100] comprises at least one transceiver unit [102], at least one processing unit [104] and at least one storage unit [106]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be connected to a user device of a target user to implement the features of the present invention. Also, in one other implementation the system may be placed in the user device to implement the features of the present invention. In yet another implementation the system [100] as a whole or partly, may be present in a server device to implement the features of the present invention.

The system [100] is configured to customize a digital platform for the target user with the help of the interconnection between the components/units of the system [100].

The transceiver unit [102] of the system [100] is configured to receive, a target user selection number of at least one high value action (HVA) on the digital platform, wherein the digital platform includes one or more high value actions. In an implementation the digital platform may be an e-commerce platform. Also in another implementation the digital platform may be any digital platform such as a social media platform, an online gaming platform, any website and the like. The high value action (HVA) is an action to be performed by a user on a digital platform, for example for an e-commerce platform a high value action (HVA) may include but not limited to a type action, a search action, a filter action, click on flyout action, a widget click action, a review action, a rating action, an offer selection action, a payment page visit action, a checkout action, an offer selection action, an edit address action, a call/chat initiated action, a return completed action, a monthly repeat action and the like. Further, the target user selection number of the at least one high value action (HVA) is a number indicating how many times the target user has selected the at least one high value action (HVA) on the digital platform. For example, on an e-commerce platform, if the target user has selected a type action (i.e. type HVA) 5 times, then in such scenario the transceiver unit [102] is configured to receive, 5 as a target user selection number of the type high value action.

Thereafter, the processing unit [104] of the system [100] is configured to determine, a quantile score for the target user based on a first set of users identified from a plurality of users on the digital platform, wherein the first set of users are identified based on the target user selection number of the at least one high value action (HVA) and a first user selection number of the at least one high value action (HVA). The first user selection number of the at least one high value action (HVA) is a number indicating how many times the first set of users has selected the at least one high value action (HVA) on the digital platform. For example, on an e-commerce platform, if the first set of users has selected/executed a filter action (i.e. filter HVA) 4 times, then in such scenario the first user selection number of the filter HVA is 4. Further, to identify the first set of users, the first user selection number of the at least one high value action (HVA) is the same or less than the target user selection number of the at least one high value action (HVA). More particularly, if for a set of users from a plurality of users, a first user selection number of a high value action (HVA) is the same or less than a target user selection number of said high value action (HVA), then such set of users is identified as the first set of users. For example, if a target user selection number of a HVA is 5, then in such scenario to identify a first set of users a first user selection number of said HVA is considered as 5 or less than 5, thereafter one or more users from a plurality of users who have executed said HVA for 5 times or lesser before placing their first order are selected as the first set of users.

Furthermore, in an implementation, the quantile score for the target user is further determined based on a percentage of the first set of users. For example, if 50 users out of 100 users are identified as the first set of users then the percentage of the 50 users i.e. 50% is considered to determine the quantile score. Further in an example, if a target user has executed on a digital platform, the Xj high value action y number of times and 50 percent of users from a plurality of users on said digital platform executed Xj HVA y or less than y number of times while placing their first order, then the quantile score (q) is determined as f(Xj)=0.5. Furthermore, in another example, if a target user on an ecommerce platform has done 8 searches (i.e. search HVA is used 8 times by the target user or the target user selection number for search HVA is 8) and 60 users from a total of 100 users on said ecommerce platform has done at least 8 searches before placing an order (i.e. 8 is the first user selection number and the identified 60 users are the first set of users), then the user percentage of the first set of users is determined as 60%. Further, the quantile score (q) i.e. f(Xj) for said user on said e-commerce platform for the search HVA is determined to be 0.6.

Further the processing unit [104] is configured to determine, an importance score for the at least one HVA based at least on a successful placement of a first order by a second set of users identified from the plurality of users, wherein the second set of users are identified based on an execution of the at least one HVA for successful placement of the first order. The first order is an order placed for the first time and the second set of users are the users who have successfully placed their first order by executing the at least one HVA. The importance score is further determined based on a probability of execution of the at least one HVA at least once prior to the successful placement of the first order. More specifically, in an implementation, P{Xj} is defined as a probability of executing a Xj HVA at least once given that a target user has placed his first order. Further, the probability of execution i.e. (P{Xj} is referred as importance score(i). For example: if 80% users (i.e. second set of users) from a plurality of users on a digital platform are using search feature/HVA before ordering a product, then in such instance the P{Xj} i.e. importance score(i) for the search HVA is determined to be 0.8. Also, in the given example, the second set of users i.e. 80% users are identified based on the execution of the search HVA by 80% users from the plurality of users, before ordering the product.

Thereafter, the processing unit [104] is configured to determine, a score for the at least one HVA based on the quantile score and the importance score associated with said at least one HVA. More specifically, for the target user the score of the at least one HVA is determined based on a product of the quantile score and the importance score of the at least one HVA. For example: if for a target user on a digital platform, the quantile score for filter HVA is determined to be f(Xi) and the importance score of the filter HVA is determined to be (P{Xi}), then for said target user the score for the filter HVA is determined based on the product of the f(Xi) and the (P{Xi}).

Also, the processing unit [104] is thereafter configured to customize, the digital platform for the target user based at least on the score of the at least one HVA. More particularly, the score of the at least one HVA further indicates a comfort score/level of the target user with respect to the at least one HVA and a digital maturity score of the target user is then determined based on such score of the at least one HVA. Further, as the digital maturity score indicates a comfort score/level of the target user with respect to the digital platform, therefore the processing unit [104] is then configured to customize the digital platform for the target user in accordance with the comfort level of the target user.

Once the score of the at least one HVA is determined, the processing unit [104] is further configured to determine a group score for the target user based on a total score of one or more HVAs present in a group selected from one or more groups. Also, a group indicates one or more steps/stages of a user during his/her user journey on the digital platform, wherein the one or more steps/stages are followed by the user by executing one or more high value actions present in said group. Furthermore, the group (i.e. the group selected from one or more groups) is one of a discover group, a research group, a purchase group, a post purchase group and a retention group. Further in an example, the discover group in an e-commerce platform comprises a sign up HVA, a product page view HVA, a type HVA, a search HVA, an auto suggest usage HVA, a click on flyout HVA, a widget click HVA, a sort HVA, a filter HVA and the like. Also, the research group in an e-commerce platform comprises a PIN code check HVA, an add to cart HVA, a social sharing HVA, a style picker HVA, a reviews HVA, a rating HVA, an add to wishlist HVA, a product description HVA and the like. Further, the purchase group in an e-commerce platform comprises an add address HVA, an edit address HVA, a payment page visit HVA, an offer selection HVA, a checkout HVA, a login HVA and the like. The post purchase group in an e-commerce platform comprises a return filed HVA, a return completed HVA, a self-help HVA, a call/chat initiated HVA and the like. Further, the retention group in an e-commerce platform comprises a monthly repeat HVA, a repeat orders HVA and the like.

Also, the processing unit [104] is further configured to determine the digital maturity score of the target user on the digital platform based on a total score of the one or more groups. In an implementation a total score of the discover group, research group, purchase group, post purchase group and the retention group for a target user on a digital platform, is determined as the digital maturity score of said target user on said digital platform.

Further, the processing unit [104] is configured to customize the digital platform for the target user based on the digital maturity score of the target user. More particularly, to customize the digital platform for the target user based on the digital maturity score of the target user, the processing unit [104] is further configured to categorize the target user in a category based on the digital maturity score. Further, the category is one of a non-user category, an occasional browser category, an occasional shopper category and a frequent shopper category. Furthermore, if the digital maturity score of the target user is below a first threshold, the target user is identified as a new user on the digital platform and categorized in the non-user category. Also, if the digital maturity score of the target user is above the first threshold and below a second threshold, the target user is identified as an occasional user on the digital platform and categorized in the occasional browser category. Further, if the digital maturity score of the target user is above the second threshold and below a third threshold, the target user is identified as an occasional shopper on the digital platform and categorized in the occasional shopper category. Also, if the digital maturity score of the target user is above the third threshold and below a fourth threshold, the target user is identified as a frequent shopper on the digital platform and categorized in the frequent shopper category.

Thereafter, the processing unit [104] in order to customize the digital platform for the target user is configured to provide in real time, at least one of one or more options and a particular user interface on a display unit of the user device, based on the category of the target user. Also, one or more options further comprises at least of one or more target (such as user specific or promotional) products, one or more user specific offers (such as discounts, cashbacks etc.), a help section and a decision assistant, a discovery assistant and the like. Further, the particular user interface further comprises one or more HVAs provided based on the category of the target user. For example if the category of the target user is non-user category the particular user interface may be a simple interface comprising one or more basic and/or important HVAs such as a shopping guide HVA, a search HVA and the like.

Further, in an implementation the processing unit [104] is further configured to update the category of the target user based on a change in the digital maturity score of the target user. Furthermore, the digital maturity score of an average user increases with increasing operations on a digital platform such as increasing number of visits, increasing number of units purchased, increasing time spent and like increasing operations on the digital platform. Therefore the processing unit [104] is further configured to update the category of one or more users based on the increase in the digital maturity score of said one or more users.

Also, once the category of the target user is updated, the processing unit [104] is thereafter configured to customize in real time the digital platform for the target user based on the updated category of the target user.

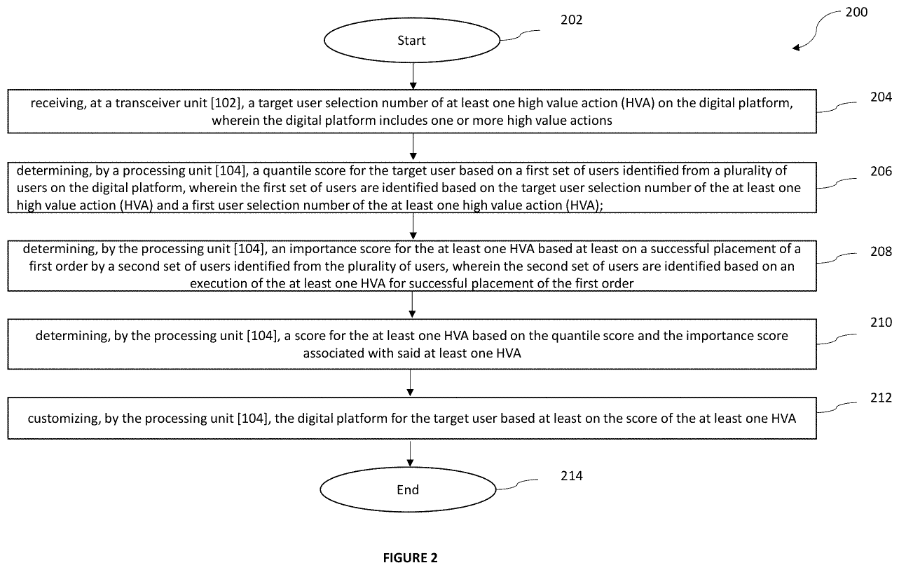

Referring to FIG. 2, an exemplary method flow diagram [200], depicting a method for customizing a digital platform for a target user, in accordance with exemplary embodiments of the present invention is shown. In an implementation the method is performed on an electronic/user device by system [100] and the digital platform is accessed by the target user on the electronic device. Also, as shown in FIG. 2, the method starts at step [202].

Thereafter at step [204] the method comprises receiving, at a transceiver unit [102], a target user selection number of at least one high value action (HVA) on the digital platform, wherein the digital platform includes one or more high value actions. In an implementation the digital platform may be one of an e-commerce platform, a social media platform, an online gaming platform, any website and the like platform. The high value action (HVA) is an action to be performed by a user on a digital platform, for example for an e-commerce platform a high value action (HVA) may include but not limited to a type action, a search action, a filter action, a review action, a rating action, an discount selection action, a payment mode selection action, a checkout action, an edit address action, a help section selection action, a return completed action, a monthly repeat action and the like. Further, the target user selection number of the at least one high value action (HVA) is a number indicating how many times the target user has selected the at least one high value action (HVA) on the digital platform. For example, on an e-commerce platform, if the target user has selected a search action (e.g., search HVA) 6 times, then in such scenario the method encompasses receiving at the transceiver unit [102], 6 as a target user selection number of the search high value action.

Further at step [206] the method comprises determining, by a processing unit [104], a quantile score for the target user based on a first set of users identified from a plurality of users on the digital platform, wherein the first set of users are identified based on the target user selection number of the at least one high value action (HVA) and a first user selection number of the at least one high value action (HVA). The first user selection number of the at least one high value action (HVA) is a number indicating a number of times the first set of users has selected the at least one high value action (HVA) on the digital platform. For example, on an e-commerce platform, if the first set of users has selected/executed a filter action (e.g., filter HVA) 4 times, then in such scenario the first user selection number of the filter HVA is 4. Further, to identify the first set of users, the first user selection number of the at least one high value action (HVA) is the same or less than the target user selection number of the at least one high value action (HVA). More particularly, if for a set of users from a plurality of users, a first user selection number of a high value action (HVA) is the same or less than a target user selection number of said high value action (HVA), then such set of users is identified as the first set of users. For example, if a target user selection number of a HVA is 8, then in such scenario to identify a first set of users a first user selection number of said HVA is considered as 8 or less than 8, thereafter one or more users from a plurality of users who have executed said HVA for 8 times or lesser before placing their first order are selected as the first set of users.

Furthermore, in an implementation, the method encompasses determining the quantile score for the target user based on a percentage of the first set of users. For example, if 70 users out of 100 users are identified as the first set of users then the percentage of the 70 users i.e. 70% is considered to determine the quantile score. Further in an example, if a target user has executed on a digital platform, the Xj high value action z number of times and 70 percent of users from a plurality of users on said digital platform executed Xj HVA z or less than z number of times while placing their first order, then the method encompasses determining the quantile score (q) as f(Xj)=0.7. Furthermore, in another example, if a target user on an ecommerce platform has done 4 searches (i.e. the target user selection number for search HVA is 4) and 90 users from a total of 100 users on said ecommerce platform has done at least 4 searches before placing an order (i.e. the first user selection number is 4 and the first set of users comprises 90 users), the method first encompasses determining a user percentage of the first set of users, i.e. 90% in the given example. Further, the method encompasses determining the quantile score (q) i.e. f(Xj) for said user on said e-commerce platform for the search HVA based on the user percentage of the first set of users. More particularly in the given example the method via the processing unit [104] determines the quantile score (q) as 0.9 based on the 90% first set of users.

Next, at step [208], the method comprises determining, by the processing unit [104], an importance score for the at least one HVA based at least on a successful placement of a first order by a second set of users identified from the plurality of users, wherein the second set of users are identified based on an execution of the at least one HVA for successful placement of the first order. The first order is an order placed for the first time and the second set of users are the users who have successfully placed their first order by executing the at least one HVA. The method further comprises determining by the processing unit [104] the importance score based on a probability of execution of the at least one HVA at least once prior to the successful placement of the first order. More specifically, in an implementation, the method comprises defining by the processing unit [104], P{Xj} as a probability of executing a Xj HVA at least once given that a target user has placed his first order. Further, the probability of execution i.e. (P{Xj} is referred as importance score(i). For example: if 60% users (i.e. second set of users) from a plurality of users on a digital platform are using filter feature/HVA before ordering a product, then in such instance the method comprises determining by the processing unit [104], the P{Xj} i.e. importance score(i) for the filter HVA as 0.6, based on the percentage of the second set of users. Also, in the given example, the method comprises identifying, the second set of users i.e. 60% users, based on the execution of the filter HVA by 60% users from the plurality of users, before ordering the product.

The method thereafter at step [210] comprises determining, by the processing unit [104], a score for the at least one HVA based on the quantile score and the importance score associated with said at least one HVA.

More specifically, the method comprises determining by the processing unit [104], the score of the at least one HVA for the target user, based on a product of the quantile score and the importance score of the at least one HVA. For example: if for a target user on a digital platform, the quantile score for filter HVA is determined to be f(Xi) and the importance score of the filter HVA is determined to be (P{Xi}), then for said target user the method comprises determining by the processing unit [104], the score for the filter HVA based on the product of the f(Xi) and the (P{Xi}).

Further the method at step [212] comprises customizing, by the processing unit [104], the digital platform for the target user based at least on the score of the at least one HVA. More particularly, the score of the at least one HVA further indicates a comfort score/level of the target user with respect to the at least one HVA on the digital platform. Also, the method further comprises determining by the processing unit [104], a digital maturity score of the target user based on such score of the at least one HVA. Further, as the digital maturity score indicates a comfort score/level of the target user with respect to the digital platform, therefore the method encompasses customizing by the processing unit [104], the digital platform for the target user in accordance with the comfort level of the target user.

Once the score of the at least one HVA is determined, the method further comprises determining a group score for the target user based on a total score of one or more HVAs present in a group selected from one or more groups. Also, a group indicates one or more steps/stages of a user during his/her user journey on the digital platform, wherein the one or more steps/stages are followed by the user by executing one or more high value actions present in said group. Furthermore, the group (i.e. the group selected from the one or more groups) is one of a discover group, a research group, a purchase group, a post purchase group and a retention group. Further in an example, the discover group in an e-commerce platform comprises a sign up HVA, a product page view HVA, a type HVA, a search HVA, an auto suggest usage HVA, a click on flyout HVA, a widget click HVA, a sort HVA, a filter HVA and the like. Also, the research group in an e-commerce platform comprises a PIN code check HVA, an add to cart HVA, a social sharing HVA, a style picker HVA, a reviews HVA, a rating HVA, an add to wishlist HVA, a product description HVA and the like. Further, the purchase group in an e-commerce platform comprises an add address HVA, an edit address HVA, a payment page visit HVA, an offer selection HVA, a checkout HVA, a login HVA and the like. The post purchase group in an e-commerce platform comprises a return filed HVA, a return completed HVA, a self-help HVA, a call/chat initiated HVA and the like. Further, the retention group in an e-commerce platform comprises a monthly repeat HVA, a repeat orders HVA and the like.

After determining the group score of the one or more groups for the target user, the method further comprises determining by the processing unit [104], the digital maturity score of the target user on the digital platform based on a total score of the one or more groups. In an implementation a total score of the discover group, research group, purchase group, post purchase group and the retention group for a target user on a digital platform, is determined as the digital maturity score of said target user on said digital platform.

Further, the method encompasses customizing the digital platform for the target user based on the digital maturity score of the target user. More particularly, the step of customizing the digital platform for the target user is further based on the digital maturity score of the target user. Also, to customize the digital platform for the target user based on the digital maturity score of the target user, the method comprises categorizing by the processing unit [104], the target user in a category based on the digital maturity score. Further, the category is one of a non-user category, an occasional browser category, an occasional shopper category and a frequent shopper category. Furthermore, if the digital maturity score of the target user is below a first threshold, the target user is identified as a new user on the digital platform and categorized in the non-user category. Also, if the digital maturity score of the target user is above the first threshold and below a second threshold, the target user is identified as an occasional user on the digital platform and categorized in the occasional browser category. Further, if the digital maturity score of the target user is above the second threshold and below a third threshold, the target user is identified as an occasional shopper on the digital platform and categorized in the occasional shopper category. Also, if the digital maturity score of the target user is above the third threshold and below a fourth threshold, the target user is identified as a frequent shopper on the digital platform and categorized in the frequent shopper category.

Furthermore, the step of customizing the digital platform for the target user further comprises providing in real time by the processing unit [104], at least one of one or more options and a particular user interface on a display unit, based on the category of the target user. The one or more options further comprises at least of one or more target products, one or more user specific offers, a help section, a decision assistant, a discovery assistant and the like. The particular user interface further comprises one or more HVAs provided based on the category of the target user. For example if the category of a target user is frequent shopper category the particular user interface may comprise one or more HVAs such as a discounts/offers based on past purchases, loyalty points of the target user and the like.

Further, in an implementation the method also comprises updating by the processing unit [104], the category of the target user based on a change in the digital maturity score of the target user.

Furthermore, the digital maturity score of an average user increases with increasing operations on a digital platform such as increasing number of visits, increasing number of units purchased, increasing time spent and like increasing operations on the digital platform. Therefore the method further comprises updating by processing unit [104], the category of one or more users based on the increase in the digital maturity score of said one or more users.

Also, once the category of the target user is updated, the method further comprises customizing in real time by processing unit [104], the digital platform for the target user based on the updated category of the target user.

The method thereafter terminates at step [214].

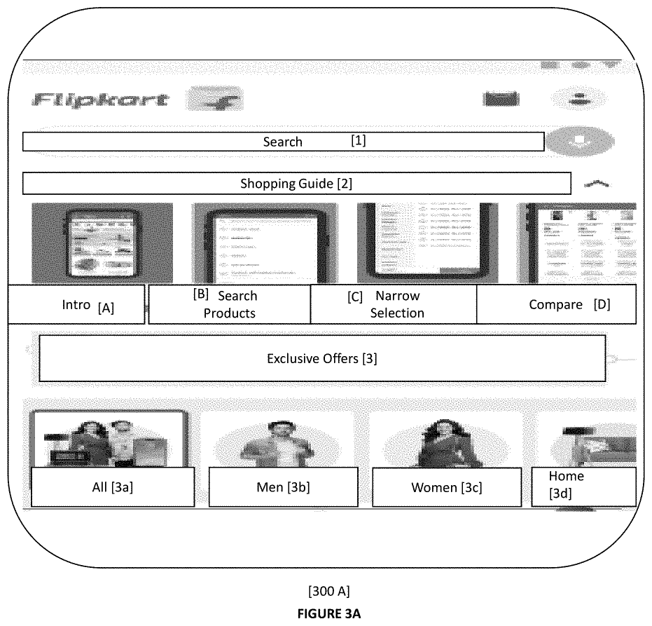

Referring to FIGS. 3A and 3B, exemplary user interface diagrams, in accordance with exemplary embodiments of the present invention is shown.

FIGS. 3A and 3B at [300 A] and [300 B] indicates two exemplary user interface diagrams, wherein each exemplary user interface [300 A] and [300 B] is a user interface of a digital platform customized for a specific user based on a digital maturity score of said specific user on the digital platform. More particularly, each of the user interface [300 A] and [300 B] depicted in the FIGS. 3A and 3B is customized based on a non-user category of the specific user, wherein the non-user category is identified based on the digital maturity score of said specific user. Further, as the non-user category indicates that the specific user is a new user on the digital platform a simpler and informative user interface is provided to the specific user.

Further, [300 A] depicts that at [1] a search high value action is provided to provide the specific user an easy access for searching products or any other information. Thereafter at [2], a shopping guide is provided for easy shopping via the digital platform, wherein the further options to access the shopping guide is provided at steps [A] to [D]. More specifically, [A] indicates an option/high value action ‘Intro’ under the high value action ‘shopping guide’, [B] indicates a high value action (HVA) ‘search products’ under the high value action ‘shopping guide’, [C] indicates a HVA ‘narrow selection’ under the HVA ‘shopping guide’ and [D] indicates a HVA ‘compare’ under the HVA ‘shopping guide’. Also, the shopping guide may further provides various tutorials and help sections for the specific user.

Thereafter, [300 A] depicts that at [3] an exclusive offer HVA is provided, wherein via the exclusive offer HVA personalized offers for the specific user may further be provided. Also, thereafter various sections/HVAs to access the exclusive offer is provided at [3a] to [3d]. More particularly, [3a] provides an HVA to select an exclusive offer available on All products. [3b] provides an HVA to select an exclusive offer available on Men products. [3c] provides an HVA to select an exclusive offer available on Women products and [3d] provides an HVA to select an exclusive offer available on Home products.

Further, [300 B] at [1] depicts that an exemplary user specific deal with a time limit i.e. 50 minutes is provided to highlight importance of an offer or value which is temporary in nature. Also, at [2] exemplary rating i.e. 90% is provided to avoid confusion of the specific user with respect to rating of a product. Thereafter [3] indicates that an exemplary bestseller product to highlight goodness and trendiness of such product. Also, at [4] a visual representation indicating a trusted product is depicted. Further, at [5] to [8] various trust makers are depicted to bring trust and assurance in the user. More specifically, at [5] at HVA indicating check product and pay is shown, at [6] a HVA indicating Free Delivery in 7 days and at [7] a HVA indicating an option to return a product is shown. Also, at [8] a ‘know more’ option is provided to the user for further information.

Further, the HVAs and the features/options as shown in the FIGS. 3A and 3B are exemplary, there may be other HVAs and/or the features/options present in a customized user digital platform based on a digital maturity score of a user.

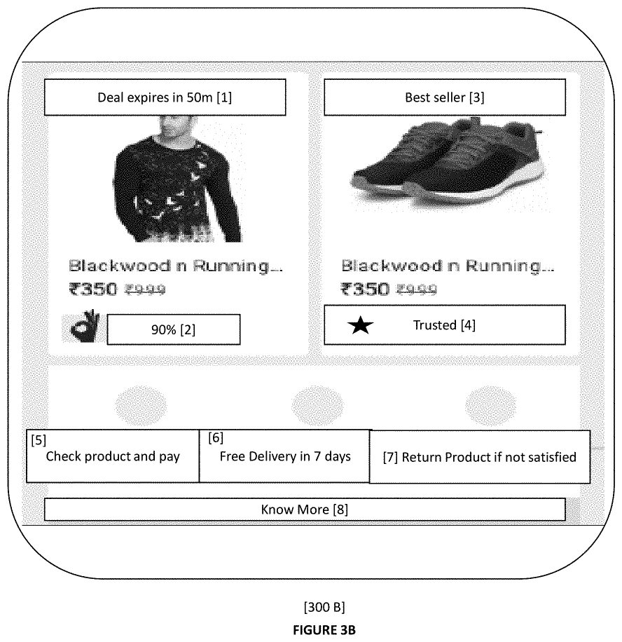

Referring to FIG. 4, an exemplary user interface diagram, in accordance with exemplary embodiments of the present invention is shown.

FIG. 4 depicts an exemplary user interface diagram indicating a digital platform customized for a specific user based on a digital maturity score of said specific user on the digital platform. More particularly, the exemplary digital platform in the FIG. 4 is customized based on an occasional browser category of the specific user, wherein the occasional browser category is identified based on the digital maturity score of said specific user.

Furthermore, FIG. 4 at [1] depicts that a search high value action is provided to provide the specific user an easy access for searching products or any other information. Thereafter at [2] exclusive offer HVA is depicted in an expanded view. Further, at [3] to [5], further sub options under the exclusive offer HVA are depicted in the expanded view to get attention of value seeker/specific user. More specifically [3] indicates a Free delivery for 1^{st} 3 orders option, [4] indicates a Rs. 200 off on 1^{st} purchase option and [5] indicates a Spin and Win Rewards option. Also, at [6] an option to view all exclusive offers is depicted.

Thereafter, FIG. 4 at [7] depicts a ‘Pay on Delivery/Pay only after receiving the product’ HVA to build trust in the specific user to make a purchase on the digital platform.

Further, the HVAs and the features/options as shown in the FIG. 4 are exemplary, there may be other HVAs and/or the features/options present in a customized user digital platform based on a digital maturity score of a user.

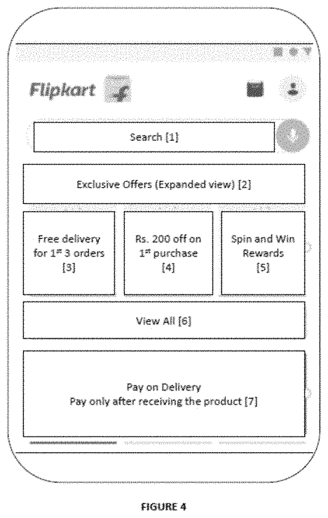

Referring to FIG. 5, an exemplary user interface diagram, in accordance with exemplary embodiments of the present invention is shown.

FIG. 5 depicts an exemplary user interface diagram indicating a digital platform customized for a specific user based on a digital maturity score of said specific user on the digital platform. More particularly, the exemplary digital platform in the FIG. 5 is customized based on an occasional shopper category of the specific user, wherein the occasional shopper category is identified based on the digital maturity score of said specific user.

Furthermore, FIG. 5 at [1] depicts that a search high value action is provided to provide the specific user an easy access for searching products or any other information. Thereafter at [2] special offer HVA is depicted to provide user specific offers. Further, at [3] a HVA ‘Complete challenges and Win Rewards’ is depicted to encourage occasional shoppers to visit the digital platform more often and complete task. Furthermore, sub options i.e. [3a]—Explore buy now and Win 10 supercoins and [3b]—Explore top deals of the day and Win 10 supercoins, are also depicted to reward the occasional shopper/specific user with supercoins to further encourage the occasional shopper to complete tasks such as to make a purchase.

Further, the HVAs and the features/options as shown in the FIG. 5 are exemplary, there may be other HVAs and/or the features/options present in a customized user digital platform based on a digital maturity score of a user.

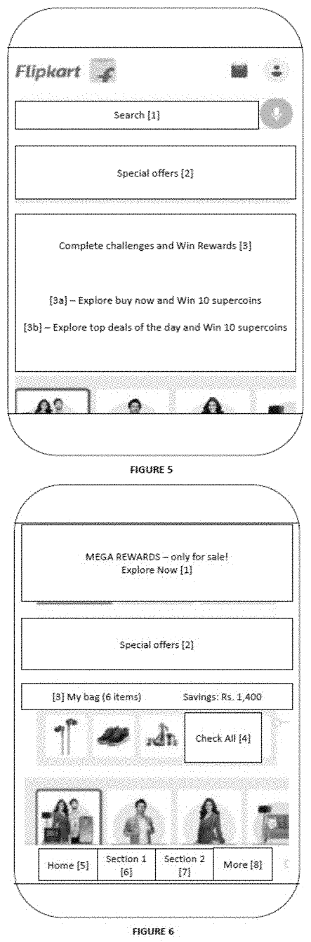

Referring to FIG. 6, an exemplary user interface diagram, in accordance with exemplary embodiments of the present invention is shown.

FIG. 6 depicts an exemplary user interface diagram indicating a digital platform customized for a specific user based on a digital maturity score of said specific user on the digital platform. More particularly, the exemplary digital platform in the FIG. 6 is customized based on a frequent shopper category of the specific user, wherein the frequent shopper category is identified based on the digital maturity score of said specific user.

Furthermore, FIG. 6 at [1] depicts a HVA ‘MEGA REWARDS—only for sale! Explore Now’ to display callouts about loyalty points and rewards to help the specific user/frequent buyer to derive more value from the digital platform. Thereafter at [2] special offer HVA is depicted to provide user specific offers. Further, at [3] a HVA ‘My bag (6 items) Savings: Rs. 1,400’ is depicted to remind the specific user the shortlisted products and total savings based on the shortlisted products. Further to check all the shortlisted products a HVA ‘Check All’ is provided at [4].

Thereafter, [5] to [8] depicts user specific various HVAs, such as at [5] a home HVA is depicted, at [6] a section 1 HVA is depicted, at [7] a section 2 HVA is depicted and at [8] a more HVA is depicted.

Further, the HVAs and the features/options as shown in the FIG. 6 are exemplary, there may be other HVAs and/or the features/options present in a customized user digital platform based on a digital maturity score of a user.

Thus, the present invention provides a novel solution for customizing a digital platform for a target user. More particularly, the present invention provides a solution to customize a digital platform based on a digital maturity score of a particular user, wherein the digital maturity score indicates a digital maturity/comfort of the particular user on the digital platform. Furthermore, the present invention provides a solution to determine the comfort of the particular user on the digital platform based on determination of a score of various high value actions on the digital platform. Also, the present invention provides a solution to determine a score of one or more groups on a digital platform comprising the high value actions. Furthermore, the present invention also provides a solution to categories a user in various categories based on the digital maturity score of the user to further customize the digital platform based on the category of the user.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for customizing a digital platform for a target user, the method comprising:
receiving, at a transceiver unit [102], a target user selection number of at least one high value action (HVA) on the digital platform, wherein the digital platform includes one or more high value actions;
determining, by a processing unit [104], a quantile score for the target user based on a first set of users identified from a plurality of users on the digital platform, wherein the first set of users are identified based on the target user selection number of the at least one high value action (HVA) and a first user selection number of the at least one high value action (HVA);
determining, by the processing unit [104], an importance score for the at least one HVA based at least on a successful placement of a first order by a second set of users identified from the plurality of users, wherein the second set of users are identified based on an execution of the at least one HVA for successful placement of the first order;
determining, by the processing unit [104], a score for the at least one HVA based on the quantile score and the importance score associated with said at least one HVA; and
customizing, by the processing unit [104], the digital platform for the target user based at least on the score of the at least one HVA.

2. The method as claimed in claim 1 wherein the first user selection number of the at least one high value action (HVA) is same or less than the target user selection number of the at least one high value action (HVA).

3. The method as claimed in claim 1, wherein the importance score is further determined based on a probability of execution of the at least one HVA at least once prior to the successful placement of the first order.

4. The method as claimed in claim 1, the method further comprises determining a group score for the target user based on a total score of one or more HVAs present in a group selected from one or more groups.

5. The method as claimed in claim 4, wherein the group is one of a discover group, a research group, a purchase group, a post purchase group and a retention group.

6. The method as claimed in claim 5, the method further comprises determining a digital maturity score of the target user on the digital platform based on a total score of the one or more groups.

7. The method as claimed in claim 6, wherein customizing the digital platform for the target user is further based on the digital maturity score of the target user.

8. The method as claimed in claim 6, the method further comprises categorizing by the processing unit [104], the target user in a category based on the digital maturity score.

9. The method as claimed in claim 8, the method further comprises updating by the processing unit [104], the category of the target user based on a change in the digital maturity score of the target user.

10. The method as claimed in claim 8, wherein customizing the digital platform for the target user further comprises providing in real time by the processing unit [104], at least one of one or more options and a particular user interface on a display unit, based on the category of the target user.

11. The method as claimed in claim 8, wherein the category is one of a non-user category, an occasional browser category, an occasional shopper category and a frequent shopper category.

12. The method as claimed in claim 10, wherein the one or more options further comprises at least of one or more target products, one or more user specific offers, a help section, a decision assistant and a discovery assistant.

13. The method as claimed in claim 10, wherein the particular user interface further comprises one or more HVAs provided based on the category of the target user.

14. A system for customizing a digital platform for a target user, the system comprising:
a transceiver unit [102], configured to receive, a target user selection number of at least one high value action (HVA) on the digital platform, wherein the digital platform includes one or more high value actions;
a processing unit [104], configured to:
determine, a quantile score for the target user based on a first set of users identified from a plurality of users on the digital platform, wherein the first set of users are identified based on the target user selection number of the at least one high value action (HVA) and a first user selection number of the at least one high value action (HVA),
determine, an importance score for the at least one HVA based at least on a successful placement of a first order by a second set of users identified from the plurality of users, wherein the second set of users are identified based on an execution of the at least one HVA for successful placement of the first order,
determine, a score for the at least one HVA based on the quantile score and the importance score associated with said at least one HVA, and
customize, the digital platform for the target user based at least on the score of the at least one HVA.

15. The system as claimed in claim 14, wherein the first user selection number of the at least one high value action (HVA) is same or less than the target user selection number of the at least one high value action (HVA).

16. The system as claimed in claim 14, wherein the importance score is further determined based on a probability of execution of the at least one HVA at least once prior to the successful placement of the first order.

17. The system as claimed in claim 14, wherein the processing unit [104] is further configured to determine a group score for the target user based on a total score of one or more HVAs present in a group selected from one or more groups.

18. The system as claimed in claim 17, wherein the group is one of a discover group, a research group, a purchase group, a post purchase group and a retention group.

19. The system as claimed in claim 18, wherein the processing unit [104] is further configured to determine a digital maturity score of the target user on the digital platform based on a total score of the one or more groups.

20. The system as claimed in claim 19, wherein the processing unit [104] is further configured to customize the digital platform for the target user based on the digital maturity score of the target user.

21. The system as claimed in claim 19, wherein the processing unit [104] is further configured to categorize the target user in a category based on the digital maturity score.

22. The system as claimed in claim 21, wherein the processing unit [104] is further configured to update the category of the target user based on a change in the digital maturity score of the target user.

23. The system as claimed in claim 22, wherein the processing unit [104] to customize the digital platform for the target user is configured to provide in real time, at least one of one or more options and a particular user interface, on a display unit, based on the category of the target user.

24. The system as claimed in claim 21, wherein the category is one of a non-user category, an occasional browser category, an occasional shopper category and a frequent shopper category.

25. The system as claimed in claim 23, wherein the one or more options further comprises at least of one or more target products, one or more user specific offers, a help section, a decision assistant and a discovery assistant.

26. The system as claimed in claim 23, wherein the particular user interface further comprises one or more HVAs provided based on the category of the target user.
